(19) United States
(12) Patent Application Publication
(10) Pub. No.: US 2003/0227731 A1
(43) Pub. Date: Dec. 11, 2003

(54) Surface mountable laminated circuit protection device

(75) Inventors: Chien-Shan Huang, PanChiau City (TW); Rei-Yian Chen, HsinChu Hsien (TW); Chih-Yi Chang, ChangHua Hsien (TW)

Correspondence Address: Ladas & Parry, 26 West 61st Street, New York, NY, 10023, US

(73) Assignee: PROTECTRONICS TECHNOLOGY CORPORATION

(21) Appl. No.: 10/429,636

(22) Filed: May 5, 2003

(30) Foreign Application Priority Data
Jun. 6, 2002 (TW) 091208382

(51) Int. Cl. H02H 5/04

(52) U.S. Cl. 361/103

(57) ABSTRACT

The invention discloses a surface mountable laminated circuit protection device by using a conductive composite material with PTC characteristics. The design of the invention enables the combinational arrangements of a top electrode, a bottom electrode and an insulating material between electrodes without using a conductive mechanism between the top electrode and the bottom electrodes to make a surface mountable polymeric circuit protection device, and can use the current double-layer metal-foil clad substrate as a processing substrate, make the processing of the protection device easier, and have better structural strength and dimension stability.

### BACKGROUND OF THE INVENTION

The invention relates to a surface mountable laminated circuit protection device, more particularly to a surface mountable laminated circuit protection device with the characteristics of a positive temperature coefficient (PTC) thermal sensitive resistor.

PTC devices have been extensively used in the fields of temperature detection, safety control, temperature compensation, etc. In the past, a thermal sensitive resistance device primarily used ceramic as materials. However, ceramic needed to be manufactured at a higher temperature, usually higher than 900 degree centigrade. Much energy had to be consumed, and the process was more complex. A polymeric thermal sensitive resistance device was developed later. The manufacturing temperature of the polymeric thermal sensitive resistance device is below 300 degree centigrade, processing and molding are easier, less energy is consumed, process is easy, and costs are cheaper, and thus the application fields are becoming more extensive.

The conventional PTC circuit protection device can be made by using polymeric composite materials filled by conductive fillers. The polymeric composite material filled by the conductive fillers has the PTC characteristics, and it is in the low-resistance state at room temperature. When the current through the polymeric composite material is too large, causing the temperature of the polymeric composite material to reach a certain switching temperature, the resistance of the polymeric composite material filled by the conductive filler would rise rapidly to avoid critical components of a circuit being burned down. Therefore, it can be applied in the current overloading protection device and the design of the temperature switching device. This is due to the fact that the conductive filling particles in the polymeric composite material filled by the conductive filler are at the conducting state of connecting to each other at room temperature. When the temperature rises above the switching temperature, the volume of the resin material in the polymeric composite material expands, causing conductive filling particles in the polymeric composite material to transform from the state of connecting to each other to expand to break to become an discontinuous state so as to cause the resistance of the PTC circuit protection device to rise rapidly to cut off the current, thereby achieving the objectives of current overloading protection and temperature-controlled switch.

The conventional PTC laminated structure uses the conductive composite material component with a top layer and a bottom layer metal foils and an intermediate layer with the PTC characteristics. It arranges with a lateral conductive mechanism and an insulating material to electrically conduct the top layer and bottom layer metal electrodes of the conductive composite material component with the PTC characteristics to another plane to make the surface mountable circuit protection device.

The aforementioned prior art techniques use the conductance between the first electrode and second electrode to make the surface mountable polymeric circuit protection device. The difference between them resides in that the former uses a plated through hole to conduct and that the later uses the lateral conductive layer to make the conductive mechanism to conduct. No matter whether the plated through hole or the lateral conductive layer is used, the expansion of the conductive composite material with the PTC characteristics is limited as the temperature rises such that the conductive composite material sometimes cannot discontinuous characteristics be fully expanded and the optimum breakdown property cannot be achieved.

These techniques mainly adopt the metal foils and the conductive composite material components with the PTC characteristics. The PTC laminated structure is formed after the thermal laminating, then electroplating, etching, plated through hole, and dipping electroplating processes are conducted. First of all, the metal foils, the conductive composite material component with PTC characteristics, and the PTC laminated structure formed by thermal laminating metal foils have insufficient mechanical strength, and are prone to wrapping to deform during the above processes. After circuits are made, thermal laminating of other PTC laminated structures, the insulation reinforcement material or the metal electrode to form multiple-layer PTC laminated structure will cause the problem of how to align top and bottom layers accurately. When the metal foil and conductive composite material with the PTC characteristics are processed, because of the material is flexible so the shortcomings of possible wrapping during the processing, deformation, poor dimension stability, and uneasy processing are more likely to occur.

Secondly, how to design a surface mountable laminated circuit protection device to make the conductive composite material components with the PTC characteristics have the parallel connecting effect, thereby causing the surface mountable laminated circuit protection device to have more extensive application fields, is one of the industrial needs when solving these manufacturing and processing issues.

### THE OBJECTIVE OF THE INVENTION

One main objective of the present invention is to provide a surface mountable laminated circuit protection device, using the conductive composite material component itself with the PTC characteristics along with the top layer electrode, the bottom layer electrode, and the lateral insulating material between electrodes to make the surface mountable polymeric circuit protection device without using the conductive mechanism between top layer and bottom layer electrodes.

The other objective of the present invention is to provide a surface mountable laminated circuit protection device to make the conductive composite material component with the PTC characteristics is expanded ed sufficiently due to the increased temperature so as to expand to break completely to become a discontinuous state, thereby allowing the conductive composite material component with the PTC characteristics to have an optimum break down characteristics property during the current overloading.

Another objective of the present invention is to provide a surface mountable laminated circuit protection device. The surface mountable laminated circuit protection device adopts double-sided metal foil clad substrate as the foundation during the structural manufacturing process, then use the mature process of the current printed circuit board so as to make the processing and manufacturing of the laminated circuit protection device easier.

Another objective of the present invention is to provide a surface mountable laminated circuit protection device in order to obtain better structural strength and dimension stability.

Another objective of the present invention is to provide a surface mountable laminated circuit protection device in order to be further developed into a parallel surface mountable laminated circuit protection device.

### SUMMARY OF THE INVENTION

In order to achieve the above objectives of the invention, the present invention provides a surface mountable laminated circuit protection device, and it comprises a first portion of a first conductive electrode, a second portion of a first conductive electrode, a conductive first composite material component with the PTC characteristics, and a first conductive layer. Where in the first portion of the first conductive electrode and the second portion of the first conductive electrode are separated by a first isolation trench. The conductive first composite material component with PTC characteristics is provided above the first portion of the first conductive electrode and the second portion of the first conductive electrode. And the thickness of the conductive first composite material component with the PTC characteristics is smaller than the width of the first isolation trench. The first conductive layer is provided above the conductive first composite material component with the PTC characteristics, causing most currents flowing from the first portion of the first conductive electrode to the first conductive layer through the conductive first composite material component with the PTC characteristics, then flowing to the second portion of the first conductive electrode through the conductive first composite material component with the PTC characteristics.

Based upon the above description, the present invention provides a surface mountable laminated circuit protection device, in which most currents flow from the first portion of the first conductive electrode to the first conductive layer through the conductive first composite material component with the PTC characteristics, then flow to the second element of the first conductive electrode through the conductive first composite material component with the PTC characteristics. There are not any plated through holes or lateral conductive layers between the first conductive layer and the first portion of the first conductive electrode or between the first conductive layer and the second portion of the first conductive electrode such that the conductive first composite material component with the PTC characteristics can fully expand due to the increased temperature to expand to break completely to become an discontinuous state, thereby allowing the surface mountable laminated circuit protection device to have characteristics an optimum break down property during the current overloading.

In addition, the present invention can further provide a reinforcement insulating layer above the first conductive layer, and provide a second conductive layer above the reinforcement insulating layer. The first conductive layer, the reinforcement insulating layer, and the second conductive layer can be replaced by the double-sided metal foil clad substrate, and the mature process of the current printed circuit board can be used such that the processing and manufacturing of the surface mountable laminated circuit protection device are easier.

Furthermore, adopting the double-sided metal foil clad substrate as the foundation to manufacture, hardness and strength is superior, thereby having better structural strength and dimension stability.

Furthermore, the present invention can be further developed such that the conductive second composite material component with the PTC characteristics can be provided above the second conductive layer and the first portion of the second conductive electrode and the second portion of the second conductive electrode can be provided above the conductive second composite material component with the PTC characteristics. The first portion of the second conductive electrode and the second portion of the second conductive electrode are separated by a second isolation trench. The first portion of the second conductive electrode electrically conducts the first portion of the first conductive electrode by using a first conductive mechanism, and the second portion of the second conductive electrode electrically conducts the second portion of the first conductive electrode by using a second conductive mechanism, but the first conductive mechanism and the second conductive mechanism do not physically contact the first conductive layer and the second conductive layer.

The current can further flow to the second portion of the first conductive electrode through the first element of the first conductive electrode, the first conductive mechanism, the first portion of the second conductive electrode, the conductive second composite material component with the PTC characteristics, and the second conductive layer, then through the conductive second composite material component with the PTC characteristics, the second portion of the second conductive electrode, the second conductive mechanism; or the current can further flow to the second portion of the first conductive electrode to be electrically turned on through the first portion of the first conductive electrode, the conductive first composite material component with the PTC characteristics, and the first conductive layer, then through conductive first composite material component with the PTC characteristics. Therefore, the present invention can realize the parallel surface mountable laminated circuit protection device, and have more extensive applications.

The features and other effects of the present invention are described with the following embodiments.

### BRIEF DESCRIPTION OF THE DRAWINGS

FIG. 1 is the elements decomposing figure of the circuit protection device of the first embodiment of the present invention;

FIG. 2 is the design example of a first conductive electrode layer and a second conductive electrode layer being a cross-shaped interleaving pattern;

FIG. 3 is the design example of a first conductive electrode layer and a second conductive electrode layer being a z-shaped interleaving pattern;

FIG. 4 is the design example of a first conductive electrode layer and a second conductive electrode layer being an s-shaped interleaving pattern;

FIG. 5 is the circuit protection device of the second embodiment of the present invention;

FIG. 6 is the circuit protection device of the third embodiment of the present invention;

FIG. 7 is the circuit protection device of the fourth embodiment of the present invention; and

FIG. 8 is the circuit protection device of the fifth embodiment of the present invention.

Reference Numerals of Major Parts in the Drawings:

| | |
|---|---|
| 10 | laminated circuit protection device of the first embodiment of the |
| | present invention |
| 11 | second conductive electrode layer |
| 11A | first portion of the second conductive electrode layer |
| 11B | second portion of the second conductive electrode layer |
| 12 | first conductive electrode layer |
| 12A | first portion of the first conductive electrode layer |
| 12B | second portion of the first conductive electrode layer |
| 13 | first conductive composite material component with the PTC |
| | characteristics |
| 14 | top insulating layer |
| 15 | bottom insulating layer |
| 17 | first isolation trench |
| 19 | second isolation trench |
| 21 | third-terminal electrode |
| 22 | fourth-terminal electrode |
| 23 | first-terminal electrode |
| 24 | second-terminal electrode |
| 30 | laminated circuit protection device of the second embodiment of |
| | the present invention |
| 31 | first conductive layer |
| 32 | second conductive layer |
| 33 | first conductive electrode layer |
| 33A | first portion of the first conductive electrode layer |
| 33B | second portion of the first conductive electrode layer |
| 34 | first conductive composite material component with the PTC |
| | characteristics |
| 35 | reinforcement insulating layer |
| 36 | composite electroplating layer |
| 37 | bottom insulating layer |
| 38 | top insulating layer |
| 41 | first-terminal electrode |
| 42 | second-terminal electrode |
| 50 | laminated circuit protection device of the third embodiment of the |
| | present invention |
| 51 | first conductive layer |
| 52 | second conductive layer |
| 53 | reinforcement insulating layer |
| 54 | first conductive electrode layer |
| 54A | first portion of the first conductive electrode layer |
| 54B | second portion of the first conductive electrode layer |
| 55 | upper-most layer metal electrode layer |
| 55A | first portion of the upper-most layer metal electrode layer |
| 55B | second portion of the upper-most layer metal electrode layer |
| 56 | first conductive composite material component with the PTC |
| | characteristics |
| 57 | second conductive composite material component with the PTC |
| | characteristics |
| 58 | bottom insulating layer |
| 59 | upper-most layer metal electrode layer first insulating layer |
| 61 | first-terminal electrode |
| 62 | second-terminal electrode |
| 63 | third-terminal electrode |
| 64 | fourth-terminal electrode |
| 100 | laminated circuit protection device of the fourth embodiment of the |
| | present invention |
| 101 | first conductive layer |
| 102 | second conductive layer |
| 102A | first portion of the first conductive layer |
| 102B | second portion of the first conductive layer |
| 103 | reinforcement insulating layer |
| 111 | first conductive composite material component with the PTC |
| | characteristics |
| 112 | first conductive electrode layer |
| 112A | first portion of the first conductive electrode layer |
| 112B | second portion of the first conductive electrode layer |
| 113 | first conductive mechanism |
| 114 | second conductive mechanism |
| 120 | laminated circuit protection device of the fifth embodiment of the |
| | present invention |
| 121 | first conductive layer |
| 122 | second conductive layer |
| 123 | reinforcement insulating layer |
| 124 | first conductive composite material component with the PTC |
| | characteristics |
| 125 | second conductive composite material component with the PTC |
| | characteristics |
| 126 | first conductive electrode layer |
| 126A | first portion of the first conductive electrode layer |
| 126B | second portion of the first conductive electrode layer |
| 127 | second conductive electrode layer |
| 127A | first portion of the second conductive electrode layer |
| 127B | second portion of the second conductive electrode layer |
| 129 | first conductive mechanism |
| 130 | second conductive mechanism |
| 131 | bottom insulating layer |
| 132 | top insulating layer |
| 133 | first-terminal electrode |
| 134 | second-terminal electrode |
| 135 | third-terminal electrode |
| 136 | fourth-terminal electrode |
| 141 | top insulating layer |
| 142 | bottom insulating layer |
| 151 | third-terminal electrode |
| 152 | fourth-terminal electrode |
| 153 | first-terminal electrode |
| 154 | second-terminal electrode |

### DETAILED DESCRIPTION OF THE INVENTION

First Embodiment:

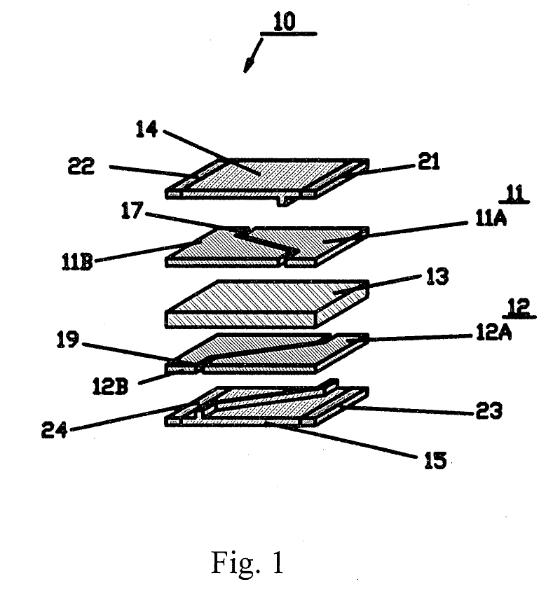

Please refer to FIG. 1, the surface mountable laminated circuit protection device of the first embodiment of the present invention, and it comprises a first-terminal electrode 23, a second-terminal electrode 24, and a bottom insulating layer 15 on the first layer location according to a bottom-up order. Going one layer up is a first conductive electrode layer 12, and it can be further divided as a first portion 12A of a first conductive electrode layer and a second portion 12B of a first conductive electrode layer. Going further up are a conductive first composite material component 13 with a PTC characteristics, and a second conductive electrode layer 11, which is further divided into a first portion 11A of a second conductive electrode layer and a second portion 11B of a second conductive electrode layer. Going further up are a third-terminal electrode 21, a fourth-terminal electrode 22, and a top insulating layer 14.

The first portion 12A of the first conductive electrode layer and the second portion 12B of the first conductive electrode layer are separated by a first isolation trench 19. The conductive first composite material component 13 with the PTC characteristics is provided above the first portion 12A of the first conductive electrode layer and the second portion 12B of the first conductive electrode. The thickness of the conductive first composite material component 13 with the PTC characteristics is smaller than the smallest width of the first isolation trench 19. And the first portion 11A of the second conductive electrode layer and the second portion 11B of the second conductive electrode layer are separated by a second isolation trench 17. And the conductive first composite material component 13 with the PTC characteristics is provided below the first portion 11A of the second conductive electrode layer and the second portion 11B of the first conductive electrode. And the thickness of the conductive first composite material component 13 with the PTC characteristics is smaller than the smallest width of the second isolation trench 17.

Or, the smallest distance between the first portion 12A of the first conductive electrode and the first portion 11A of the second conductive electrode, the smallest distance between the first portion 12A of the first conductive electrode and the second portion 11B of the second conductive electrode, the smallest distance between the second portion 12B of the first conductive electrode and the first portion 11A of the second conductive electrode, and the smallest distance between the second portion 12B of the first conductive electrode and the second portion 11B of the second conductive electrode are all less than the smallest distance between the first portion 12A of the first conductive electrode and the second portion 12B of the first conductive electrode and the smallest distance between the first portion 11A of the second conductive electrode and the second portion 11B of the second conductive electrode.

The first conductive electrode layer 12 is provided below the conductive first composite material component 13 with the PTC characteristics, causing most currents to flow from the first portion 12A of the first conductive electrode to the first portion 11A of the second conductive electrode and the second portion 11B of the second conductive electrode respectively through the conductive first composite material component 13 with the PTC characteristics, then flow to the second portion 12B of the first conductive electrode through the conductive first composite material component 13 with the PTC characteristics.

The conductive first composite material component 13 with the PTC characteristics in this embodiment is a carbon black filled conductive crystalline polymeric composite material. And the crystalline polymeric material can be polyethylene, polypropylene, and polyvinyl fluoride and its co-polymers. Carbon black uses carbon black Raven 450 (a product of U.S. Columbian Corporation). In this embodiment, carbon black and crystalline polymeric composite material with the weight ratio of 1 to 1 are mixed with a brabender mixer at 210 degree centigrade for eight minutes, and are thermally molded with a heated press at 175 degree centigrade to form plate-shaped conductive composite laminated material with the PTC characteristics and a thickness of about 0.5 mm.

The conductive metal foils, such as nickel foil, copper foil, and their alloy, can be the first conductive electrode layer 12 and the second conductive electrode layer 11. In this embodiment, nickel electroplated copper foil is used.

As for insulating layers 14 and 15, materials with the insulating effect can be used. Normally, insulating solder mask is used.

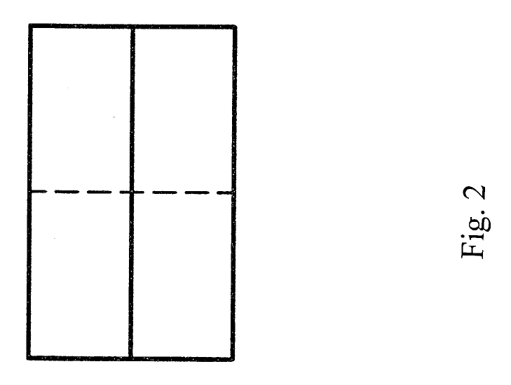

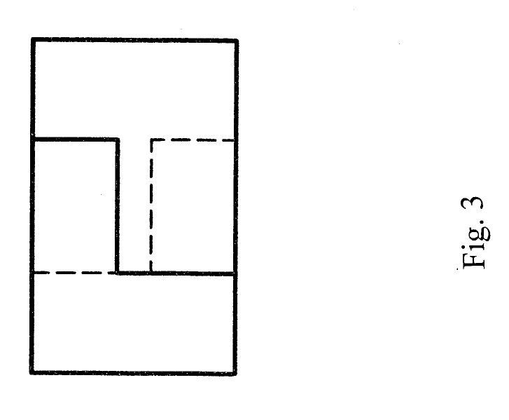

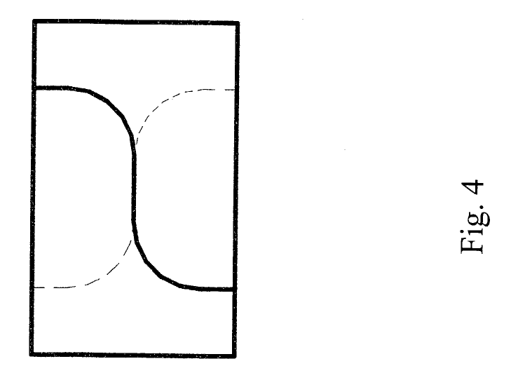

In the above embodiment, a first portion 11A of the second conductive electrode and a second portion 11B of the second conductive electrode above, and the first portion 12A of the first conductive electrode and the second portion 12B of the first conductive electrode below can use the cross-shaped, z-shaped, and s-shaped interleaving patterns as shown in FIG. 2, FIG. 3, and FIG. 4, or similar pattern designs to make circuits more variable so as to adjust the resistance value.

Second Embodiment:

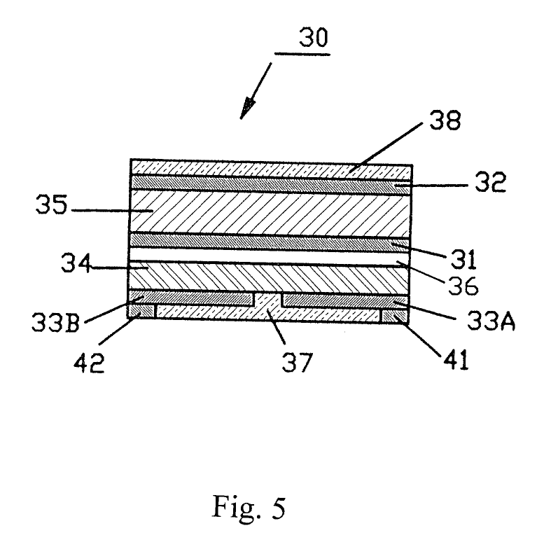

Please refer to FIG. 5, the second embodiment of the surface mountable laminated circuit protection device of the present invention, which comprises a first-terminal electrode 41, a second-terminal electrode 42, and a bottom insulating layer 37, a first portion 33A of a first conductive electrode, a second portion 33B of a first conductive electrode, a conductive first composite material component 34 with a PTC characteristics, a first conductive layer 31, a reinforcement insulating layer 35, a second conductive layer 32, and a top insulating layer 38 according to a bottom-up order.

The first portion 33A of the first conductive electrode and the second portion 33B of the first conductive electrode are separated by a first isolation trench (unmarked). The conductive first composite material component 34 with the PTC characteristics is provided above the first portion 33A of the first conductive electrode and the second portion 33B of the first conductive electrode. And the thickness of the conductive first composite material component 34 with the PTC characteristics is smaller than the width of the first isolation trench.

Or, the distance between the first portion 33A of the first conductive electrode and the first conductive layer 31, and the distance between the second portion 33B of the first conductive electrode and the first conductive layer 31 are both smaller than the smallest distance between the first portion 33A of the first conductive electrode and the second portion 33B of the first conductive electrode.

The first conductive layer 31 is provided above the conductive first composite material component 34 with the PTC characteristics for such that the most currents flow to the first conductive layer 31 from the first portion 33A of the first conductive electrode through the conductive first composite material component 34 with the PTC characteristics, then to the second portion 33B of the first conductive electrode through the conductive first composite material component 34 with the PTC characteristics.

The first conductive layer 31, the reinforcement insulating layer 35, and the second conductive layer 32 can use a double-side metal foil substrate like the approximate 35 μm-thick double-side metal foil substrate in the present invention, such that the present invention can use the mature process of the current printed circuit board to make the processing and manufacturing of the circuit protection device easier.

In this embodiment, the conductive first composite material component 34 with the PTC characteristics is a carbon black filled conductive crystalline polymeric composite material. The crystalline polymeric material can be polyethylene, polypropylene, and polyvinyl fluoride and its co-polymers. Carbon black uses carbon black Raven 450 (a product of U.S. Columbian Corporation). In this embodiment, carbon black and crystalline polymeric composite material with the weight ratio of 1 to 1 are mixed with a brabender mixer at 210 degree centigrade for eight minutes, and are thermally molded with a heated press to the plate-shaped conductive composite material with the PTC characteristics and a thickness of about 0.5 mm.

The combining of the first conductive layer 31 and the conductive first composite material component 34 with the PTC characteristics can use carbon black composite electroplating process such that the composite electroplating layer 36 of the continuous porous structure with carbon black and metal is formed between the conductive first composite material component 34 with the PTC characteristics and the first conductive layer 31. Good connections with the lower interface resistance between the metal electrode and the conductive composite material with the PTC characteristics can be formed by using this continuous porous structure.

As for insulating layers 37 and 38, materials with the insulating effect can be used. Normally, insulating solder mask can be used.

Third Embodiment:

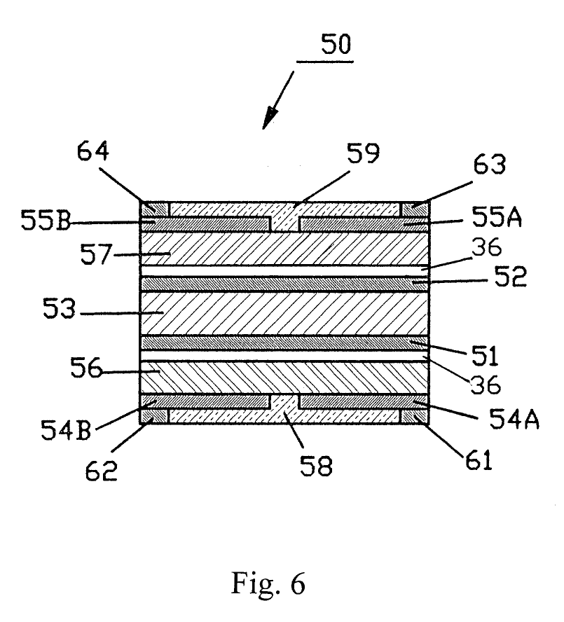

Please refer to FIG. 6, the third embodiment of the present invention.

The third embodiment symmetrically stacks two protection devices of the second embodiment, and further comprises a third-terminal electrode 63, a fourth-terminal electrode 64, a top insulating layer 59, a first portion 55A of the second conductive electrode, a second portion 55B of the second conductive electrode, and the conductive second composite material component 57 with the PTC characteristics (but the top insulating layer 38, which is the top insulating layer 38 of FIG. 5, is not added). And the double-sided metal foil clad substrate portion (including the first conductive layer 51, the reinforcement insulating layer 53, and the second conductive layer 52 portions) in between can be shared.

The formed laminated circuit protection device 50 can increase structural symmetry, have better structural strength, have better dimension stability, and are convenient in use.

Fourth Embodiment:

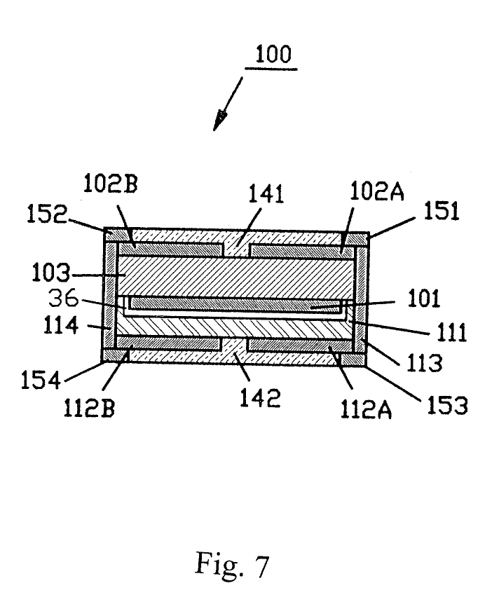

Please refer to FIG. 7, the fourth embodiment of the present invention, derived from the second embodiment (FIG. 5), but in which the second conductive layer 102 of the double-side metal foil is divided into two portions of a first portion 102A of the second conductive layer and a second portion 102B of the second conductive layer, and it is separated by a second isolation trench (unmarked).

The first portion 102A of the second conductive layer electrically conducts the first portion 112A of the first conductive electrode with a first conductive mechanism 113. And the second portion 102B of the second conductive layer electrically conducts the second portion 112B of the first conductive electrode with a second conductive mechanism 114. Furthermore, the first conductive mechanism 113 and the second conductive mechanism 114 do not physically contact the first conductive layer 101.

Similarly, a first-terminal electrode 153, a second-terminal electrode 154, a third-terminal electrode 151 and a fourth-terminal electrode 152 can be provided respectively above the first portion of the first conductive electrode, the second portion of the first conductive electrode, the first portion of the second conductive electrode, and the second portion of the second conductive electrode. Insulating layers 141 and 142 can be provided between the terminal electrodes.

In this embodiment, the first conductive mechanism 113 and the second conductive mechanism 114 can use the conventional method of plated through holes.

Fifth Embodiment:

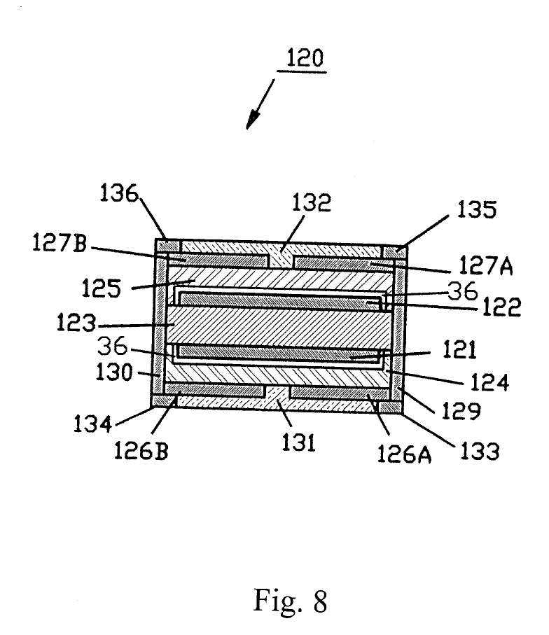

Please refer to FIG. 8, the fifth embodiment of the present invention.

This embodiment is derived from the design of the above third embodiment (FIG. 6), and further comprises a first conductive mechanism 129 and a second conductive mechanism 130. The first portion 127A of the second conductive electrode electrically conducts the first portion 126A of the first conductive electrode with a first conductive mechanism 129, and the second portion 127B of the second conductive electrode electrically conducts the second portion 126B of the first conductive electrode with a second conductive mechanism 130. And the first conductive mechanism 129 and the second conductive mechanism 130 do not physically contact the first conductive layer 121 and the second conductive layer 122.

The current can flow to the second portion 126B of the first conductive electrode through the first portion 126A of the first conductive electrode, the first conductive mechanism 129, the first portion 127A of the second conductive electrode, the conductive second composite material component 125 with the PTC characteristics, the second conductive layer 122, then through the conductive second composite material component 125 with the PTC characteristics, the second portion 127B of the second conductive electrode, and the second conductive mechanism 130; or flows to second portion 126B of the first conductive electrode to be electrically conducting through the first portion 126A of the first conductive electrode, the conductive first composite material component 124 with the PTC characteristics, and the first conductive layer 121, then through the conductive first composite material component 124 with the PTC characteristics. Therefore, the parallel connecting surface mountable laminated circuit protection device can have more extensive applications.

Similarly, in this embodiment, the first conductive mechanism 129 and the second conductive mechanism 130 uses the conventional method of plated through holes.

Based upon the above description, the provided surface mountable laminated circuit protection devices of the first embodiment, the second embodiment, and the third embodiment of the present invention use the conductive composite material component with the PTC characteristics itself along with the top layer and bottom layer electrodes, and the insulating materials between electrodes to be able to make the surface mountable polymeric circuit protection device without using the conductive mechanism between the top layer and the bottom layer electrodes, such that the conductive composite material component with the PTC characteristics can fully expand due to the increased temperature to expand to break completely to reach a discontinuous state, thereby causing the conductive composite material component with the PTC characteristics to have the optimum break down characteristics during the current overloading, when the current overloads.

Since the first conductive layer, the reinforcement insulating layer and the second conductive layer of the present invention can use the existing double-sided metal foil clad substrate as the foundation, and can use the mature process of the current printed circuit board during the structural manufacturing, thereby making the processing and manufacturing of the laminated circuit protection device easier and having better structural strength and dimension stability.

What needs to be explained is, although the fourth embodiment and the fifth embodiment still use the method of plated through holes such that the conductive composite material with the PTC characteristics cannot fully expand due to the increased temperature to expand to break completely to become a discontinuous state during their applications like the first embodiment, the second embodiment, and the third embodiment, but they can use the mature process of the current printed circuit board to make the processing and manufacturing of the surface mountable laminated circuit protection device easier. In addition, they adopt the double-sided metal foil clad substrate as the foundation to manufacture, hardness and strength are superior, thereby having the advantages of better structural strength and dimension stability.

Although the present invention is described using the above embodiments, it does not mean that the scope of the present invention is limited to the above description. Persons skilled in the art can make all kinds of modifications, for example, changing the selected polymeric material, introducing different conductive particles, changing electroplating conditions, changing constituent weight ratio, increasing the numbers of layers, increasing the turn-on modes of different internal circuits, or using different pattern designs of the isolation trench on the metal layers to achieve the same effects. However, these modifications shall not deviate from the spirit of the present invention, and they still belong to the protective scope of the present invention. The protective scope of the present invention shall be limited to the description of the claims.

What is claimed is:

1. A surface mountable laminated circuit protection device, comprising:
a first portion of a first conductive electrode and a second portion of a first conductive electrode, the first portion of the first conductive electrode and the second portion of the first conductive electrode being separated by a first isolation trench;
a conductive first composite material component with a PTC characteristics provided above the first portion of the first conductive electrode and the second portion of the first conductive electrode, the thickness of the conductive first composite material component with the PTC characteristics being less than the width of the first isolation trench; and
a first conductive layer provided above the conductive first composite material component with the PTC characteristics such that most currents flow from the first portion of the first conductive electrode to the first conductive layer through the conductive first composite material component with the PTC characteristics, then to the second portion of the first conductive electrode through the conductive first composite material component with the PTC characteristics.

2. The surface mountable laminated circuit protection device of claim 1, wherein the first conductive layer is further provided with a reinforcement insulating layer thereon, and the reinforcement insulating layer is provided with a second conductive layer thereon.

3. The surface mountable laminated circuit protection device of claim 2, wherein the second conductive layer is further provided with a top insulating layer thereon.

4. The surface mountable laminated circuit protection device of claim 1, wherein the first portion of the first conductive electrode is provided with a first-terminal electrode thereon, the second portion of the first conductive electrode is provided with a second-terminal electrode thereon, and a bottom insulating layer is provided between the first-terminal electrode and the second-terminal electrode.

5. The surface mountable laminated circuit protection device of claim 2, wherein the second conductive layer is provided with the conductive second composite material component with the PTC characteristics thereon, and the conductive second composite material component with the PTC characteristics is provided with a first portion of a second conductive electrode and a second portion of a second conductive electrode thereon, the first portion of the second conductive electrode and the second portion of the second conductive electrode being separated by a second isolation trench.

6. The surface mountable laminated circuit protection device of claim 5, wherein the first portion of the first conductive electrode is provided with a first-terminal electrode thereon, the second portion of the first conductive electrode is provided with a second-terminal electrode thereon, and a bottom insulating layer is provided between the first-terminal electrode and the second-terminal electrode.

7. The surface mountable laminated circuit protection device of claim 5, wherein the first portion of the second conductive electrode is provided with a third-terminal electrode thereon, the second portion of the second conductive electrode is provided with a fourth-terminal electrode, and a top insulating layer is provided between the third-terminal electrode and the fourth-terminal electrode.

8. The surface mountable laminated circuit protection device of claim 2, wherein the second conductive layer is divided into two portions of the first portion of the second conductive layer and the second portion of the second conductive layer, the two portions are separated by a second isolation trench, first portion of the second conductive layer electrically conducts to first portion of the first conductive electrode with a first conductive mechanism, the second portion of the second conductive layer electrically conducts to second portion of the first conductive electrode with a second conductive mechanism, the first conductive mechanism and the second conductive mechanism not physically contacting the first conductive layer.

9. The surface mountable laminated circuit protection device of claim 8, wherein the first portion of the second conductive layer is provided with a first-terminal electrode thereon, the second portion of the second conductive layer is provided with a second-terminal electrode thereon, and a top insulating layer is provided between the first-terminal electrode and the second-terminal electrode.

10. The surface mountable laminated circuit protection device of claim 8, wherein the first isolation trench and the second isolation trench are of the same shape, but are at opposite locations.

11. The surface mountable laminated circuit protection device of claim 5, wherein the first portion of the second conductive electrode electrically conducts to the first portion of the first conductive electrode with a first conductive mechanism, and the second portion of the second conductive electrode electrically conducts to the second portion of the first conductive electrode with a second conductive mechanism, the first conductive mechanism and the second conductive mechanism do not physically contacting the first conductive layer and the second conductive layer.

12. The surface mountable laminated circuit protection device of claim 1, wherein the first isolation trench and the second isolation trench are of the same shape.

13. The surface mountable laminated circuit protection device of claim 11, wherein the first isolation trench and the second isolation trench are at symmetrical locations.

14. A circuit protection device, comprising:
a conductive first composite material component with a PTC characteristics,
a first electrode and a second electrode being separated; provided below the first composite material component, and the smallest distance between the first electrode and the second electrode being larger than the thickness of the first composite material component; and
a first conductive layer provided above the first composite material component, and the distance between the first electrode and the first conductive layer and the distance between the second electrode and the first conductive layer both being smaller than the smallest distance between the first electrode and the second electrode.

15. The circuit protection device of claim 14, wherein the first conductive layer is further provided with a reinforcement insulating layer thereon, and the reinforcement insulating layer is provided with a second conductive layer thereon.

16. The circuit protection device of claim 15, wherein the second conductive layer is further provided with a top insulating layer thereon.

17. The circuit protection device of claim 15, wherein the second conductive layer is provided with the conductive second composite material component with the PTC characteristics thereon, and the conductive second composite material component with the PTC characteristics is provided with a third electrode and a fourth electrode, which are separated, the smallest distance between the third electrode and the fourth electrode being larger than the thickness of the second composite material component.

18. The circuit protection device of claim 17, wherein the third electrode electrically connects to the first electrode with a first conductive mechanism, and the fourth electrode electrically connects to the second electrode with a second conductive mechanism.

19. The circuit protection device of claim 15, wherein the second conductive layer is divided into a third electrode and a fourth electrode, which are separated, the third electrode electrically connecting to the first electrode with a first conductive mechanism, the fourth electrode electrically connecting to the second electrode with a second conductive mechanism, and the first conductive mechanism and the second conductive mechanism do not physically contacting the first conductive layer.
